(19) United States
(12) Patent Application Publication
(10) Pub. No.: US 2025/0298401 A1
(43) Pub. Date: Sep. 25, 2025

(54) ELECTRONIC DEVICE AND OPERATING METHOD THEREOF FOR DETERMINING OPERATION MODE OF FACTORY ENERGY MANAGEMENT SYSTEMS

(71) Applicant: Electronics and Telecommunications Research Institute, Daejeon (KR)

(72) Inventors: Marie Kim, Daejeon (KR); Tae-Wook Heo, Sejong-si (KR); Il Woo Lee, Daejeon (KR)

(21) Appl. No.: 19/083,048

(22) Filed: Mar. 18, 2025

(30) Foreign Application Priority Data
Mar. 19, 2024 (KR) 10-2024-0037746
Feb. 13, 2025 (KR) 10-2025-0018816

(51) Int. Cl. G05B 19/418

(52) U.S. Cl. CPC G05B 19/41845; G05B 19/4185

(57) ABSTRACT

An electronic device and an operating method thereof for determining an operation mode of factory energy management systems (FEMSs) are provided. The electronic device includes a processor and a memory configured to store instructions. The instructions, when executed by the processor, cause the electronic device to determine, according to status information of a plurality of FEMSs, an operation mode of each of the plurality of FEMSs, and in response to a request from a target FEMS, which is one of the plurality of FEMSs, transmit a corresponding operation mode to the target FEMS, wherein the target FEMS is configured to operate data in the operation mode received from the electronic device, and wherein the plurality of FEMSs is connected to each other via a blockchain network to share data.

### CROSS-REFERENCE TO RELATED APPLICATION

This application claims the benefit of Korean Patent Application No. 10-2024-0037746 filed on Mar. 19, 2024 and 10-2025-0018816 filed on Feb. 13, 2025, in the Korean Intellectual Property Office, the entire disclosures of which are incorporated herein by reference for all purposes.

### BACKGROUND

### 1. Field of the Invention

One or more embodiments relate to an electronic device and an operating method thereof for determining an operation mode of factory energy management systems (FEMSs).

### 2. Description of the Related Art

A factory energy management system (FEMS) may refer to a system that monitors or analyzes energy consumption by using data related to energy used in a factory. A FEMS may analyze patterns of energy-related data to manage equipment in the factory or control the operation of the equipment. Research on a FEMS is being conducted to efficiently manage energy consumption in a factory and increase energy efficiency. Distributed system technology is a technology in which a plurality of independent systems is connected to each other and operate as a single system, which may be used in various fields such as computing, networking, data management, and security.

The above description is information the inventor(s) acquired during the course of conceiving the present disclosure, or already possessed at the time, and is not necessarily art publicly known before the present application was filed.

### SUMMARY

Embodiments provide an electronic device for determining an operation mode of each of a plurality of factory energy management systems (FEMSs), according to status information of the plurality of FEMSs.

Embodiments provide an electronic device for determining an operation mode of a plurality of FEMSs from among a standalone (or an independent) mode, a peer-to-peer mode, and a master-slave mode, according to the operation mode of the plurality of FEMSs.

Embodiments provide an electronic device for utilizing a blockchain network and artificial intelligence to allow a plurality of FEMSs to share data with each other in a distributed manner.

Other objects and advantages of the present disclosure can be understood by the following description and will become more apparent by the embodiments of the present disclosure.

According to an aspect, there is provided an electronic device including a processor and a memory configured to store instructions, wherein the instructions, when executed by the processor, cause the electronic device to determine, according to status information of a plurality of factory energy management systems (FEMSs), an operation mode of each of the plurality of FEMSs, and in response to a request from a target FEMS, which is one of the plurality of FEMSs, transmit a corresponding operation mode to the target FEMS, wherein the target FEMS is configured to operate data in the operation mode received from the electronic device, and wherein the plurality of FEMSs is connected to each other via a blockchain network to share data.

The operation mode of each of the plurality of FEMSs may include a peer-to-peer mode and a master-slave mode, and the target FEMS may be configured to share data with another FEMS corresponding to the target FEMS when operating data in the peer-to-peer mode, and share data in a manner in which data of a FEMS corresponding to a slave is transmitted to a FEMS corresponding to a master when operating data in the master-slave mode.

When executed by the processor, the instructions may cause the electronic device to change, according to the status information of the plurality of FEMSs, the operation mode of each of the plurality of FEMSs to another operation mode, or change a FEMS corresponding to a master and a FEMS corresponding to a slave in the master-slave mode.

When executed by the processor, the instructions may cause the electronic device to monitor load states of a memory, an amount of computations, or traffic of the plurality of FEMSs and determine the operation mode of each of the plurality of FEMSs according to the load states.

When executed by the processor, the instructions may cause the electronic device to determine, according to an operation mode of the plurality of FEMSs, a sharing range of data that each of the plurality of FEMSs shares.

When executed by the processor, the instructions may cause the electronic device to obtain business contexts of a subject that operates the plurality of FEMSs, and determine the operation mode of each of the plurality of FEMSs according to the business contexts.

The plurality of FEMSs may be configured to optimize an operation of equipment included in a FEMS by using data received from another FEMS.

The plurality of FEMSs may be configured to store, in the blockchain network, a data sharing request and a data transmission history between each other, and determine a presence of data forgery by using the blockchain network.

According to an aspect, there is provided an operating method of an electronic device, the operating method including determining, according to status information of a plurality of FEMSs, an operation mode of each of the plurality of FEMSs, in response to a request from a target FEMS, which is one of the plurality of FEMSs, transmit a corresponding operation mode to the target FEMS, wherein the target FEMS may be configured to operate data in the operation mode received from the electronic device, and wherein the plurality of FEMSs may be connected to each other via a blockchain network to share data.

The operation mode of each of the plurality of FEMSs may include a peer-to-peer mode and a master-slave mode, and the target FEMS may be configured to share data with another FEMS corresponding to the target FEMS when operating data in the peer-to-peer mode and share data in a manner in which data of a FEMS corresponding to a slave is transmitted to a FEMS corresponding to a master when operating data in the master-slave mode.

The operating method may further include, according to the status information of the plurality of FEMSs, changing the operation mode of each of the plurality of FEMSs to another operation mode, or changing a FEMS corresponding to a master and a FEMS corresponding to a slave in the master-slave mode.

The determining of the operation mode may include monitoring load states of a memory, an amount of computations, or traffic of the plurality of FEMSs and determining the operation mode of each of the plurality of FEMSs according to the load states.

The determining of the operation mode may include determining, according to an operation mode of the plurality of FEMSs, a sharing range of data that each of the plurality of FEMSs shares.

The determining of the operation mode may include obtaining business contexts of a subject that operates the plurality of FEMSs and determining the operation mode of each of the plurality of FEMSs according to the business contexts.

The plurality of FEMSs may be configured to optimize an operation of equipment included in a FEMS by using data received from another FEMS.

The plurality of FEMSs may be configured to store, in the blockchain network, a data sharing request and a data transmission history between each other, and determine a presence of data forgery by using the blockchain network.

Additional aspects of embodiments will be set forth in part in the description which follows and, in part, will be apparent from the description, or may be learned by practice of the disclosure.

According to embodiments, an electronic device may determine an operation mode of each of a plurality of FEMSs, according to status information of the plurality of FEMSs, to allow the FEMSs to process information independently or as an association depending on the situation.

According to embodiments, an electronic device may utilize blockchain technology and artificial intelligence technology to allow safe and transparent information sharing between FEMSs and optimized system operation based on real-time data analysis.

According to embodiments, an electronic device may reduce the cost of system reconstruction by allowing companies to change an operation mode of FEMSs by changing system settings without reconstructing a system due to situations such as business expansion or reduction.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a factory energy management system (FEMS) and an electronic device, according to an embodiment;

FIG. 2 is a diagram illustrating an operation mode of a FEMS, according to an embodiment;

FIG. 3 is a diagram illustrating a master-slave operation mode according to an embodiment;

FIG. 4 is a flowchart illustrating an operating method of an electronic device, according to an embodiment; and

FIG. 5 is a block diagram illustrating an electronic device, according to an embodiment.

### DETAILED DESCRIPTION

The following detailed structural or functional description is provided as an example only and various alterations and modifications may be made to the embodiments. Thus, an actual form of implementation is not construed as limited to the embodiments described herein and should be understood to include all changes, equivalents, and replacements within the idea and the technical scope of the disclosure.

As used herein, each of phrases such as “A or B,” “at least one of A and B,” “at least one of A or B,” “A, B, or C,” “at least one of A, B, and C,” “at least one of A, B, or C,” and “one or a combination of two or more of A, B, and C” may include any one of the items listed together in the corresponding one of the phrases or all possible combinations thereof. Although terms, such as first, second, and the like are used to describe various components, the components are not limited to the terms. These terms should be used only to distinguish one component from another component. For example, a first component may be referred to as a second component, and similarly, the second component may also be referred to as the first component.

It should be noted that when one component is described as being “connected,” “coupled,” or “joined” to another component, the first component may be directly connected, coupled, or joined to the second component, or a third component may be “connected,” “coupled,” or “joined” between the first and second components.

The singular forms “a,” “an,” and “the” are intended to include the plural forms as well, unless the context clearly indicates otherwise. It will be further understood that the terms “comprises/comprising” and/or “includes/including,” when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical and scientific terms have the same meanings as those commonly understood by one of ordinary skill in the art to which this disclosure pertains. Terms such as those defined in commonly used dictionaries are to be interpreted as having a meaning that is consistent with their meaning in the context of the relevant art and are not to be interpreted in an idealized or overly formal sense unless expressly so defined herein.

Hereinafter, the embodiments are described in detail with reference to the accompanying drawings. When describing the embodiments with reference to the accompanying drawings, like reference numerals refer to like components and a repeated description related thereto is omitted.

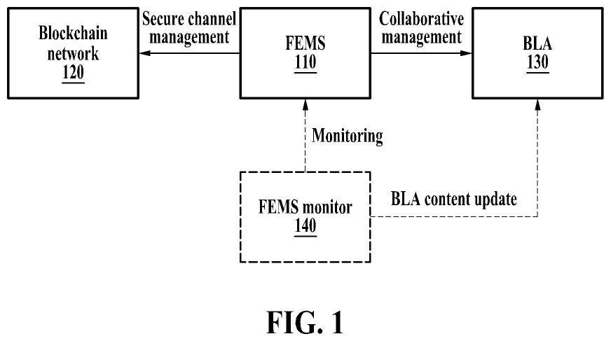

FIG. 1 is a diagram illustrating a factory energy management system (FEMS) and an electronic device, according to an embodiment.

Referring to FIG. 1, an energy management system according to an embodiment may include a FEMS 110, a blockchain network 120, and a business level agreement (BLA) 130. In addition, the energy management system may further include a FEMS monitor 140. In this specification, for ease of description, the energy management system may also be referred to as the FEMS 110.

The FEMS 110 may obtain energy-related data from a factory, manage energy usage patterns and operating states of devices based on the obtained data, and perform optimization simulations. The FEMS 110 may independently provide functions for obtaining, storing, analyzing, and visualizing factory energy data, and may operate in a standalone mode, a peer-to-peer mode, or a master-slave mode depending on settings. The FEMS 110 may be a target of actual data sharing and control when data sharing with other FEMSs or data control is required.

The blockchain network 120 may be a commercial blockchain network or a blockchain network built for an association between FEMSs. The blockchain network 120 may provide authentication, data integrity, and audit functions to safely support the FEMS association, thereby ensuring safe recording and retrieval of results of mutual associated operation of FEMSs and reliability in the FEMS 110 that is a subject of association. The blockchain may not store actual data transmitted and received when the FEMSs are associated but may store and manage transaction contents as to which data and control signals were transmitted and received, when the transmission and reception occurred, and who performed the transmission and reception. However, a method of providing integrity or a method of managing a key for authentication of the FEMSs utilized by the blockchain network 120 may be determined differently depending on the embodiment, and the embodiment is not limited to a specific method. In cases in which collaboration is required and thus data sharing is required, each FEMS may share and store the corresponding data, thereby mitigating a security threat that may increase when all data is managed centrally. The blockchain network 120 may utilize blockchain functions to perform authentication between FEMSs, data integrity, and auditing of transactions.

The BLA 130 may determine whether each FEMS 110 may operate in a standalone mode, a peer-to-peer mode, or a master-slave mode, which FEMS each FEMS 110 may be associated with when associating, what level of information may be shared, or what level of control may be shared, and the like. For example, the BLA 130 may determine the following for each FEMS 110.
1. Definition of operation mode (operation type: a standalone mode, a peer-to-peer mode, and a master-slave mode, definition of roles and switching conditions of master and slave, operation switching conditions: criteria for changing the operation mode according to a load state, a data processing capability, or a network situation)
2. Data sharing range (no data shared in the case of standalone mode, shared data items (e.g., energy consumption and equipment status) and sharing cycle in the case of peer-to-peer mode, data range and control authority of slave accessible by master in the case of master-slave mode)
3. Data confidentiality and access control information
4. Authentication and security information
5. Load management and role switching
6. Failure and recovery procedures
7. Whether to utilize recommended information from the FEMS monitor 140

For example, the BLA 130 may determine the operation of each FEMS 110 as shown in Table 1 below.

TABLE 1

| Item | Content |
|---|---|
| Operation | Selection from among a standalone mode, a |
| mode | peer-to-peer mode, and a master-slave mode; |
| | and switching conditions |
| | In the case of peer-to-peer mode: Connection |
| | information on peers to be connected to (e.g., ID, IP, |
| | port address, and information on connection protocol) |
| | In the case of master-slave mode: Information whether |
| | a corresponding FEMS is a master or a slave, and |
| | connection information on a FEMS to be connected to |
| Data sharing | Field name definition and encryption method of |
| range | necessary data (e.g., energy consumption and |
| | equipment status data), range of data to be shared |
| | (e.g., start and end of data to receive, or receiving |
| | data in a predetermined time unit from a determined |
| | timepoint) |
| Authentication | Ensure reliability between FEMSs through digital |
| method | signature and public key authentication |
| Role switching | Switch to slave when the integrated load of the master |
| conditions | exceeds a predetermined value (e.g., 80%) |
| | Determine, among master candidate FEMSs, a FEMS |
| | to respond to the master, considering calculation load, |
| | communication load, and memory load |
| Transaction | Provide transparency by recording data sharing and |
| audit | control activities on blockchain |
| Failure | In the case of master failure, switch to the master |
| response | candidate FEMS within a predetermined time (e.g., |
| | 1 minute) and synchronize data |
| BLA update | Review and, when necessary, revise BLA contents |
| procedures | at predetermined time intervals (e.g., 1 year), and |
| | whether BLA contents may be changed by the |
| | FEMS monitor 140 |

The content managed by the BLA 130 may be determined by the BLA 130 or may be determined through consultation between business stakeholders regarding installation of the FEMS 110. In addition, the content managed by the BLA 130 may be modified when necessary. The BLA 130 may define and operate a dynamic operation mode of the FEMS 110. The BLA 130 may manage a business context of all dynamically operating FEMSs. For example, when a company operates a plurality of FEMSs, the company may manage the content of the BLA 130, or a professional service provider for managing the plurality of FEMSs of the company may manage the content. Alternatively, when FEMSs of a plurality of companies dynamically operate the FEMSs, the content of the BLA 130 may be defined and managed by a consultative body formed through consultation among the plurality of companies or a professional service provider for dynamic FEMS operation. According to an embodiment, the plurality of FEMSs 110 may be dynamically operated, but embodiments are not limited to a specific application scope and specific execution entity, such as a unit of corporate, a unit of plurality of corporates, a regional unit, or a unit of association of operators in the same domain.

The FEMS monitor 140 may monitor a current data storage capacity, an operation processing capability, and a communication load of each of the FEMSs in real time. In addition, the FEMS monitor 140 may update the content of the BLA 130 based on the monitored data. The FEMS monitor 140 may obtain a current load level of all operating FEMSs from each FEMS and predict a load of each FEMS based on the obtained load level. The FEMS monitor 140 may determine an optimal association method (e.g., changing a master) based on the content of the BLA 130 and change the content of the BLA 130. The changed content may be transmitted to each FEMS 110 so that the association method between the FEMSs may be changed. A function of changing the content of the BLA 130 may be implemented by utilizing artificial intelligence technology. According to an embodiment, the FEMS monitor 140 may analyze load data of each FEMS to determine an association method at a specific timepoint. For example, when load degrees and computing capability data patterns of a FEMS 2 and a FEMS 1 corresponding to the master are similar, the FEMS monitor 140 may determine a role of the FEMS 2 to be a master of FEMSs having a high load or lower data storage capabilities and operation processing capabilities. The FEMS monitor 140 may determine the role of the FEMS 110 based on rules or determine the role of the FEMS 110 by using a machine learning technique based on obtained data. In addition, the FEMS monitor 140 may not be utilized considering complexity of the entire energy management system.

According to an embodiment, the electronic device may include the BLA 130. The electronic device may further include the FEMS monitor 140. The electronic device may represent a device (e.g., a server) or a system that manages a plurality of FEMSs and determines operation modes of the plurality of FEMSs.

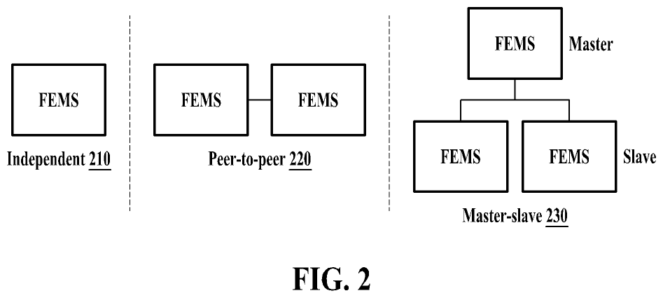

FIG. 2 is a diagram illustrating an operation mode of a FEMS, according to an embodiment.

Referring to FIG. 2, an electronic device may determine one of a standalone mode 210, a peer-to-peer mode 220, and a master-slave mode 230 as an operation mode of a FEMS. The FEMS may operate in one of the standalone mode 210, the peer-to-peer mode 220, and the master-slave mode 230, depending on the determined operation mode.

Each FEMS may be operated independently or share data and control with other FEMSs as needed. Each FEMS may obtain energy-related information of a managed factory and provide analysis information such as an energy usage status, a usage pattern, energy efficiency, and energy unit efficiency, as well as data pattern information, and may perform energy saving through device control as needed.

In the case of the standalone mode 210, the FEMS may be operated independently without sharing data with other FEMSs.

In the case of the peer-to-peer mode 220 association, each FEMS may share information from other FEMSs with equal qualification. Integrated processing of data may be possible for both FEMSs. Each FEMS may perform data analysis for multi-FEMSs by providing information based on data the FEMS obtained or performing analysis based on integrated data shared by connecting peer-to-peer. In the case of FEMSs that use a same process but different process equipment, the FEMSs may analyze energy efficiency of process equipment of other peers, compare the energy efficiency with energy efficiency of process equipment of the FEMS, and recommend equipment replacement to a manager.

In the case of the master-slave mode 230 association, a FEMS having a master role may share information and control resources from a FEMS having a slave role and may perform integrated processing of the information and the control resources. For example, when a company has a plurality of sites, FEMSs that manage the sites may operate in a master-slave manner similar to a cloud. When companies form a cooperative relationship and share information and control resources, the electronic device may operate FEMSs of the companies in the master-slave mode 230. Through this, the electronic device may set a FEMS of a determined company to operate as a master and FEMSs of the other companies as slaves so that the FEMS of the master role may perform integrated information analysis for a plurality of companies. When a load on a memory, computing, or networking of the FEMS operating as the master increases, the FEMS operating as the slave may be replaced with the master role, depending on the situation. A BLA may determine a role of a FEMS.

For example, the electronic device may allow a plurality of FEMSs to be operated according to one of the operating modes 210, 220, and 230 as in scenarios below.

### Scenario 1

In the standalone mode 210, an independently operated FEMS may obtain data from sensors and measuring devices in real time, and may provide energy-related information or control a device as needed. The FEMS may access the BLA at the beginning of operation to check information on an operation mode of the FEMS. When the operation mode stored in the BLA is a standalone mode, the FEMS may perform pattern analysis, predictive analysis, and optimal control on the data the FEMS has obtained in real time.

### Scenario 2

In the master-slave mode 230, the FEMS 1 may access the BLA when booting and obtain information on an operation mode. When the FEMS 1 is set to operate as a master, the FEMS 1 may obtain information on the FEMS 2 operating as a slave and information to be shared with the FEMS 2. The FEMS 1 operating as the master may connect to a slave node by obtaining connection information on the slave node. The FEMS 1 may obtain data by requesting the data from the slave based on the shared information stored in the BLA. The FEMS 1 may perform data analysis of the FEMS 1 alone based on the obtained data, or may process tasks such as integrated analysis including information of nodes connected to the slave and visualize the analyzed data to a user.

When a FEMS monitor is used, the FEMS monitor may periodically obtain information such as memory capacity, an amount of computations, and an amount of network traffic of the FEMS 1 and the FEMS 2 from each FEMS. The FEMS monitor may predict a timepoint at which the load of the current master, FEMS 1, corresponds to role switching conditions stored in the BLA. The FEMS monitor may utilize various analysis techniques, such as machine learning techniques or rule-based techniques, based on the obtained data. Based on the predicted timepoint, the FEMS monitor may search for slave nodes that may be designated as a next master when the load of the master is about to reach a threshold. The FEMS monitor may store, in the BLA, a content regarding the role switching of two FEMSs based on the searched slave nodes.

### Scenario 3

In the peer-to-peer mode 220, the FEMS 1 and the FEMS 2 may access the BLA at the beginning of operation to confirm that the peer-to-peer operation mode is set and check association information and a data sharing policy. The BLA may allow the FEMS 1 and the FEMS 2 to periodically share energy consumption data and equipment status data. In addition, the BLA may be set to store authentication information and data sharing history between each FEMS through a blockchain.
\textcircled{1} Initial setting:
   The FEMS 1 and the FEMS 2 may confirm their own operation mode set to the peer-to-peer mode 220 by referring to the BLA.
   The FEMS monitor may periodically obtain and analyze the load states (e.g., memory, amount of computations, and network traffic) of the FEMS 1 and the FEMS 2.
\textcircled{2} Data sharing and blockchain storage:
   The FEMS 1 may receive an analysis result of energy consumption data through a sharing request to the FEMS 2.
   The data sharing request and transmission history may be recorded on a blockchain network. For example, a transaction indicating that “the FEMS 1 requested and received energy consumption data from the FEMS 2” may be stored on the blockchain.
   The transaction stored on the blockchain may ensure that the data has not been tampered with, and the transaction may be referenced when auditing is required.
\textcircled{3} FEMS monitor-based role switching:
   When the load of the FEMS 1 increases and the load is expected to reach a threshold stored in the BLA, the FEMS monitor may propose to switch the role of the FEMS 2 to the master and to switch the role of the FEMS 1 to the slave.
   The proposal may be stored on the blockchain network so that data integrity may be maintained.
   The new role switching information stored in the BLA may be synchronized with the FEMS 1 and the FEMS 2 and immediately reflected to the FEMS 1 and the FEMS 2.
\textcircled{4} Blockchain-based data authentication:
   Transactions occurring during a data sharing process may be authenticated and stored in the blockchain and may thus be safely protected from external threats.
   An analysis result of the FEMS monitor and role transition details may also be recorded in the blockchain, so that the entire system may be managed transparently and safely.

### Scenario 4

The FEMS monitor may monitor not only an operating status of the FEMS but also an overall energy usage of each FEMS.
\textcircled{1} BLA definition:
   The BLA may store collaboration conditions between FEMSs (e.g., sharing surplus energy when a power shortage occurs).
   The BLA may store data sharing items (e.g., real-time energy consumption and reserve energy level).
   The BLA may store a collaboration termination point (e.g., when a predetermined time has elapsed after an energy shortage is resolved).
\textcircled{2} FEMS monitor operation:
   The FEMS monitor may monitor a real-time energy supply and demand status of factories managed by each FEMS and predict a timepoint at which an energy shortage occurs.
   The FEMS monitor may identify factories that may share energy and propose control-related content to FEMSs of the corresponding factories.
   Each FEMS may perform control based on the proposal of the FEMS monitor.
\textcircled{3} Blockchain utilization:

The blockchain network may store energy sharing requests and execution history on the blockchain to ensure data integrity and transparency.

Each blockchain network may securely store FEMS energy consumption data and collaboration history.

### Scenario 5

In the peer-to-peer mode 220, a plurality of factories using the same type of equipment may be connected through a FEMS of each of the plurality of factories, and when one of the factories has relatively low energy efficiency, the BLA may optimize the energy efficiency.
\textcircled{1} BLA definition:
   The BLA may set FEMSs of a plurality of factories to be connected through the peer-to-peer mode 220 to periodically share equipment status data (e.g., equipment operation time and energy consumption).
   The BLA may store data analysis criteria (e.g., average efficiency and standard deviation of equipment).
\textcircled{2} FEMS data analysis:
   Each FEMS may compare an efficiency of its own factory equipment with an efficiency of the same equipment of a peer FEMS to identify equipment with low efficiency.
   Each FEMS may perform optimization for its own equipment using artificial intelligence technology. For example, each FEMS may perform optimization through equipment replacement or process improvement.
\textcircled{3} Blockchain utilization:
   Whenever a plurality of FEMSs connected peer-to-peer share data, a transaction for that sharing may be stored in the blockchain so that it may be audited later.

### Scenario 6

Since a plurality of companies shares sensitive data and is concerned about data leakage, each FEMS may have enhanced security and data auditing functions applied.
\textcircled{1} BLA definition:
   The BLA may store a data encryption method (e.g., advanced encryption standard (AES) encryption) and an authentication procedure (e.g., public key-based authentication).
   The BLA may store data audit items (e.g., who requested what data, when, and what data).
\textcircled{2} Data sharing between FEMSs:
   FEMSs may encrypt and share data, and when data is requested, each FEMS may mutually authenticate the data.
   The FEMS monitor may obtain and store logs of each data request and response.
\textcircled{3} Blockchain utilization:
   Each FEMS may generate an unchangeable audit log by storing data request and response records on the blockchain.
   Each FEMS may store, on the blockchain, authentication history and encryption status that occurred during a data sharing process.

### Scenario 7

When a factory A is incurring additional charges due to a surge in power usage during peak hours and a nearby factory B has spare power during non-peak hours, the two factories may basically operate independently despite being business partners. The factory A may enter into a business agreement with the factory B to cooperate when necessary to reduce costs and may set the BLA content based on the business agreement.
\textcircled{1} BLA definition: As an initial setting, both the factory A and the factory B may be set to be in the standalone mode 210. Each factory may set the BLA to share data or resources of each other in the peer-to-peer mode 220 when necessary (e.g., when a surge in energy demand is expected at one factory).
\textcircled{2} The FEMS monitor may analyze an energy usage pattern of the factory A based on energy usage of the two factories and predict a surge in power demand during peak hours. The FEMS monitor may transmit the predicted information to the BLA. The BLA may change the settings so that the factory A and the factory B may share information and resources in the peer-to-peer mode 220.
\textcircled{3} The factory A and the factory B may share data and resources based on a blockchain to cooperate with each other in the peer-to-peer mode 220. The factory A and the factory B may perform a power sharing simulation by analyzing power usage patterns and load states of both sides in real time based on data.
\textcircled{4} The factory A may distribute peak power by utilizing the spare power of the factory B.
\textcircled{5} The FEMS monitor may continuously monitor the power usage of the factory A and the factory B, and when a power demand stability of both the factory A and the factory B is maintained for a predetermined period of time, the FEMS may notify the BLA of the information.
\textcircled{6} The BLA may change the settings so that FEMSs for the factory A and the factory B operate in the standalone mode 210 again.

Through this, the BLA may reduce peak power rates, secure an energy supply stability, and enhance reliability of record management by utilizing the blockchain. Hardware and software infrastructure that may share energy between two factories may be established. In addition, the FEMS monitor may manage information on an overall energy supply and demand as well as FEMS operation status information. In the BLA, a timepoint of switching of cooperative relationship (e.g., switching between the standalone mode 210 and the peer-to-peer mode 220), a period of energy sharing, and detailed conditions may be determined differently depending on the embodiment.

According to an embodiment, the electronic device may supplement a vulnerability of a centralized authentication method by reinforcing associated security based on a blockchain. In addition, the electronic device may safely and flexibly expand and operate functions of a system by utilizing authentication, data integrity guarantee, audit, and the like through the blockchain. Considering the sensitivity of business data, a function of authenticating the system as a reliable stakeholder and leaving a record of interaction may be important from a business perspective.

According to an embodiment, a business-related system such as a FEMS may be determined to operate differently according to changes in a business environment due to expansion, reduction, and change of business. The electronic device may support more flexible use of functions of the system by determining an appropriate sharing range of information and control differently based on the business context.

According to an embodiment, the electronic device may continuously monitor an operating status of FEMSs, process load management in real time, and automatically update the details of the BLA when operating. The electronic device may determine an optimal association method by reflecting load information of a FEMS and a content of the BLA in real time by utilizing artificial intelligence technology. In addition, a distributed FEMS may be optimally operated based on the determined association method. Furthermore, when functions of the FEMS monitor expand, the scenarios for a collaboration between FEMSs may be diversified.

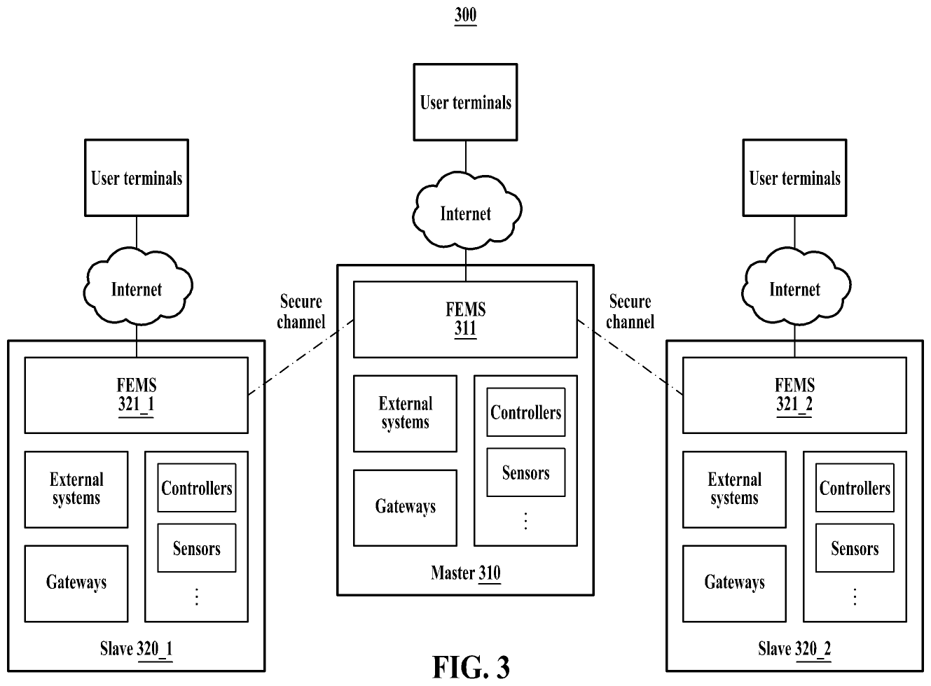

FIG. 3 is a diagram illustrating a master-slave operation mode according to an embodiment.

Referring to FIG. 3, a structure of an entire energy management system 300 is shown, in which a plurality of FEMSs 311, 321_1, and 321_2 may be operated in the master-slave operation mode. In FIG. 3, the FEMS 311 may correspond to a master 310, and the FEMS 321_1 and the FEMS 321_2 may correspond to a slave 320_1 and a slave 320_2, respectively.

Each of the plurality of FEMSs 311, 321_1, and 321_2 may be connected to sensors and controllers wiredly or wirelessly through a gateway. Each of the plurality of FEMSs 311, 321_1, and 321_2 may be connected to other external systems and transmit and receive data with the external systems. In addition, each of the plurality of FEMSs 311, 321_1, and 321_2 may be connected to user terminals via the Internet, or the like. However, the configurations of the master 310 and the slaves 320_1 and 320_2 illustrated in FIG. 3 are only examples, and the embodiment is not limited thereto. The master 310 and the slaves 320_1 and 320_2 may include various configurations in addition to the FEMS.

Each of the FEMSs 311, 321_1, and 321_2 may independently monitor and manage all information of its own factory. When necessary, the FEMS 311 of the master 310 may request necessary information from the FEMSs 321_1 and 321_2 of the slaves 320_1 and 320_2 and control equipment of the factories. Alternatively, when the FEMSs 321_1 and 321_2 of the slaves 320_1 and 320_2 lack operational capabilities or the FEMS 311 of the master 310 needs to integrate and manage operational information of the entire FEMS, a master FEMS may integrate and manage information of the FEMSs 321_1 and 321_2 for enterprise-wide management.

In order to exchange data between the FEMS 311 of the master 310 and the FEMSs 321_1 and 321_2 of the slaves 320_1 and 320_2, a secure communication channel may be established in advance. A range of control and information exchanged between a master and a slave may be defined in advance. The distributed FEMS illustrated in FIG. 3 may allow independent operation or collaboration between the FEMSs 311, 321_1, and 321_2.

The distributed FEMS may be operated from a business level contract perspective. Since a business environment may inevitably change, flexible adaptation to a FEMS operation may be required. In a specific scenario, the FEMS may be operated independently, but a situation may arise in which the FEMS needs to cooperate with other FEMSs to share information and control functions. In order to effectively respond to dynamic business conditions, a management role may be required to adjust a FEMS operation environment suitable for a business situation. For this purpose, a mechanism of a BLA may be applied.

When blockchain technology is used for secure channel management, the blockchain may establish a mutually reliable channel when operating with a FEMS. When the blockchain and the FEMS operate together, the blockchain technology may store records and processing methods of shared information and control together with mutual authentication services, thereby providing reliability in sharing sensitive information and control resources from a business perspective.

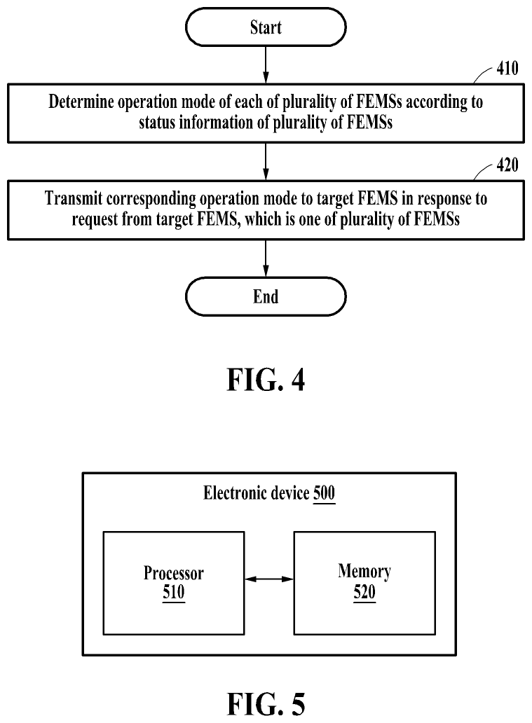

FIG. 4 is a flowchart illustrating an operating method of an electronic device, according to an embodiment.

In the following embodiments, each operation may be performed sequentially, but not necessarily. For example, the order of operations may be changed, and at least two operations may be performed in parallel. Operations 410 to 450 may be performed by at least one component (e.g., a processor) of the electronic device.

In operation 410, the electronic device may determine an operation mode of each of a plurality of FEMSs according to status information of the plurality of FEMSs. The electronic device may monitor load states of a memory, an amount of computations, or traffic of the plurality of FEMSs and may determine the operation mode of each of the plurality of FEMSs according to the load states. The electronic device may determine a sharing range of data shared by each of the plurality of FEMSs according to the operation modes of the plurality of FEMSs. The electronic device may obtain business contexts for entities operating the plurality of FEMSs and determine the operation mode of each of the plurality of FEMSs according to the business contexts.

In operation 420, the electronic device may transmit a corresponding operation mode to a target FEMS in response to a request from the target FEMS, which may be one of the plurality of FEMSs.

The electronic device may change the operation mode of each of the plurality of FEMSs to a different operation mode according to the status information of the plurality of FEMSs or may change a FEMS corresponding to a master and a FEMS corresponding to a slave in a master-slave mode.

The target FEMS may operate data in an operation mode received from the electronic device. The plurality of FEMSs may be connected to each other through a blockchain network and may share data. The plurality of FEMSs may optimize an operation of equipment included in the FEMSs by using data received from other FEMSs. The plurality of FEMSs may store, in the blockchain network, data sharing requests and data transmission history among the plurality of FEMSs, and may determine, using the blockchain network, whether data has been forged or altered.

The operation mode may include a peer-to-peer mode and a master-slave mode. When operating data in the peer-to-peer mode, the target FEMS may share the data with another FEMS corresponding to a target FEMS, and when operating data in the master-slave mode, the target FEMS may share the data so that data of a FEMS corresponding to a slave may be transmitted to a FEMS corresponding to a master.

The description provided with reference to FIGS. 1 to 3 may also apply to the operations illustrated in FIG. 4, and a more detailed description is thus omitted herein.

FIG. 5 is a block diagram illustrating an electronic device, according to an embodiment.

Referring to FIG. 5, an electronic device 500 may include a processor 510. The processor 510 may include at least one processor. In addition, the electronic device 500 may further include a memory 520.

The memory 520 may store instructions (e.g., programs) executable by the processor 510. For example, the instructions may include instructions for executing operations of the processor 510 and/or operations of each component of the processor 510.

The processor 510 may be a device that executes instructions, or programs, or controls the electronic device 500, and may include various processors such as a central processing unit (CPU) and a graphics processing unit (GPU). The processor 510 may determine an operation mode of each of a plurality of FEMSs, according to status information of the plurality of FEMSs. The processor 510 may, in response to a request from a target FEMS, which may be one of the plurality of FEMSs, transmit a corresponding operation mode to the target FEMS.

According to the status information of the plurality of FEMSs, the processor 510 may change the operation mode of each of the plurality of FEMSs to a different operation mode or may change a FEMS corresponding to a master and a FEMS corresponding to a slave in a master-slave mode. The processor 510 may monitor load states of a memory, an amount of computations, or traffic of the plurality of FEMSs and determine the operation mode of each of the plurality of FEMSs according to the load states. The processor 510 may determine, according to the operation mode of the plurality of FEMSs, a sharing range of data that each of the plurality of FEMSs shares. The processor 510 may obtain business contexts of a subject that operates the plurality of FEMSs and determine the operation mode of each of the plurality of FEMSs according to the business contexts.

The operation mode may include a peer-to-peer mode and a master-slave mode. When operating data in the peer-to-peer mode, the target FEMS may share the data with another FEMS corresponding to a target FEMS, and when operating data in the master-slave mode, the target FEMS may share the data so that data of a FEMS corresponding to a slave may be transmitted to a FEMS corresponding to a master. The plurality of FEMSs may optimize an operation of equipment included in the FEMSs by using data received from other FEMSs. The plurality of FEMSs may store, in the blockchain network, data sharing requests and data transmission history among the plurality of FEMSs, and may determine, using the blockchain network, whether data has been forged or altered.

In addition, the electronic device 500 may process the above-described operations.

The components described in the embodiments may be implemented by hardware components including, for example, at least one digital signal processor (DSP), a processor, a controller, an application-specific integrated circuit (ASIC), a programmable logic element, such as a field-programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using a hardware component, a software component, and/or a combination thereof. For example, a processing device may be implemented using one or more general-purpose or special-purpose computers, such as, for example, a processor, a controller, an arithmetic logic unit (ALU), a DSP, a microcomputer, an FPGA, a programmable logic unit (PLU), a microprocessor, or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the processing device is described as singular. However, one of ordinary skill in the art will appreciate that a processing device may include multiple processing elements and/or multiple types of processing elements. For example, the processing device may include a plurality of processors, or a single processor and a single controller. In addition, a different processing configuration is possible, such as one including parallel processors.

The software may include a computer program, a piece of code, an instruction, or one or more combinations thereof, to independently or collectively instruct or configure the processing device to operate as desired. The software and/or data may be stored in any type of machine, component, physical or virtual equipment, or computer storage medium or device for the purpose of being interpreted by the processing device or providing instructions or data to the processing device. The software may also be distributed over network-coupled computer systems so that the software is stored and executed in a distributed fashion. The software and data may be stored in a non-transitory computer-readable recording medium.

The methods according to the embodiments may be recorded in non-transitory computer-readable media including program instructions to implement various operations of the embodiments. The media may also include the program instructions, data files, data structures, and the like alone or in combination. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as floptical disks; and hardware devices that are specially configured to store and perform program instructions, such as read-only memory (ROM), random-access memory (RAM), flash memory, and the like. Examples of program instructions include both machine code, such as those produced by a compiler, and files containing high-level code that may be executed by the computer using an interpreter.

The above-described hardware devices may be configured to act as one or more software modules in order to perform the operations of the above-described embodiments, or vice versa.

Although the embodiments have been described with reference to the limited number of drawings, one of ordinary skill in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, other implementations, other examples, and equivalents to the claims are also within the scope of the following claims.

What is claimed is:

1. An electronic device comprising:
a processor; and
a memory configured to store instructions,
wherein the instructions, when executed by the processor, cause the electronic device to:
determine, according to status information of a plurality of factory energy management systems (FEMSs), an operation mode of each of the plurality of FEMSs; and
in response to a request from a target FEMS, which is one of the plurality of FEMSs, transmit a corresponding operation mode to the target FEMS,
wherein the target FEMS is configured to operate data in the operation mode received from the electronic device, and
wherein the plurality of FEMSs is connected to each other via a blockchain network to share data.

2. The electronic device of claim 1, wherein
the operation mode of each of the plurality of FEMSs comprises a peer-to-peer mode and a master-slave mode, and
the target FEMS is configured to:
share data with another FEMS corresponding to the target FEMS when operating data in the peer-to-peer mode; and
share data in a manner in which data of a FEMS corresponding to a slave is transmitted to a FEMS corresponding to a master when operating data in the master-slave mode.

3. The electronic device of claim 2, wherein the instructions, when executed by the processor, cause the electronic device to:
according to the status information of the plurality of FEMSs, change the operation mode of each of the plurality of FEMSs to another operation mode, or change a FEMS corresponding to a master and a FEMS corresponding to a slave in the master-slave mode.

4. The electronic device of claim 1, wherein the instructions, when executed by the processor, cause the electronic device to:
monitor load states of a memory, an amount of computations, or traffic of the plurality of FEMSs; and
determine the operation mode of each of the plurality of FEMSs according to the load states.

5. The electronic device of claim 1, wherein the instructions, when executed by the processor, cause the electronic device to:
determine, according to an operation mode of the plurality of FEMSs, a sharing range of data that each of the plurality of FEMSs shares.

6. The electronic device of claim 1, wherein the instructions, when executed by the processor, cause the electronic device to:
obtain business contexts of a subject that operates the plurality of FEMSs; and
determine the operation mode of each of the plurality of FEMSs according to the business contexts.

7. The electronic device of claim 1, wherein the plurality of FEMSs is configured to:
optimize an operation of equipment included in a FEMS by using data received from another FEMS.

8. The electronic device of claim 1, wherein the plurality of FEMSs is configured to:
store, in the blockchain network, a data sharing request and a data transmission history between each other; and
determine a presence of data forgery by using the blockchain network.

9. An operating method of an electronic device, the operating method comprising:
determining, according to status information of a plurality of factory energy management systems (FEMSs), an operation mode of each of the plurality of FEMSs;
in response to a request from a target FEMS, which is one of the plurality of FEMSs, transmit a corresponding operation mode to the target FEMS,
wherein the target FEMS is configured to operate data in the operation mode received from the electronic device, and
wherein the plurality of FEMSs is connected to each other via a blockchain network to share data.

10. The operating method of claim 9, wherein
the operation mode of each of the plurality of FEMSs comprises a peer-to-peer mode and a master-slave mode, and
the target FEMS is configured to:
share data with another FEMS corresponding to the target FEMS when operating data in the peer-to-peer mode; and
share data in a manner in which data of a FEMS corresponding to a slave is transmitted to a FEMS corresponding to a master when operating data in the master-slave mode.

11. The operating method of claim 10, further comprising:
according to the status information of the plurality of FEMSs, changing the operation mode of each of the plurality of FEMSs to another operation mode, or changing a FEMS corresponding to a master and a FEMS corresponding to a slave in the master-slave mode.

12. The operating method of claim 9, wherein the determining of the operation mode comprises:
monitoring load states of a memory, an amount of computations, or traffic of the plurality of FEMSs; and
determining the operation mode of each of the plurality of FEMSs according to the load states.

13. The operating method of claim 9, wherein the determining of the operation mode comprises:
determining, according to an operation mode of the plurality of FEMSs, a sharing range of data that each of the plurality of FEMSs shares.

14. The operating method of claim 9, wherein the determining of the operation mode comprises:
obtaining business contexts of a subject that operates the plurality of FEMSs; and
determining the operation mode of each of the plurality of FEMSs according to the business contexts.

15. The operating method of claim 9, wherein the plurality of FEMSs is configured to:
optimize an operation of equipment included in a FEMS by using data received from another FEMS.

16. The operating method of claim 9, wherein the plurality of FEMSs is configured to:
store, in the blockchain network, a data sharing request and a data transmission history between each other; and
determine a presence of data forgery by using the blockchain network.
